(19) United States
(12) Patent Application Publication
(10) Pub. No.: US 2021/0301948 A1
(43) Pub. Date: Sep. 30, 2021

(54) MECHANICAL ELECTRICAL AND PLUMBING HANGER SYSTEM

(71) Applicant: Katerra Inc., Menlo Park, CA (US)

(72) Inventors: John Edward Breshears, Portland, OR (US); James Mehlos, Everett, WA (US); Mark Andrew Colborn, Sacramento, CA (US); Katy Bradford, Phoenix, AZ (US); Darrin Griechen, Spokane, WA (US)

(73) Assignee: Katerra Inc., Menlo Park, CA (US)

(21) Appl. No.: 17/218,501

(22) Filed: Mar. 31, 2021

Related U.S. Application Data
(60) Provisional application No. 63/002,492, filed on Mar. 31, 2020.

(51) Int. Cl. F16L 3/14; E04B 1/343

(52) U.S. Cl. CPC F16L 3/14; E04B 1/34321

(57) ABSTRACT

A mechanical, electrical, and plumbing (MEP) hanger is provided. The MEP hanger includes a base, a body, and a strap. The base includes a pin. The pin is configured to engage with an opening in at least one of a web joist, a transverse hanger arm, and a mid-bay hanger arm. The body is attached to the base. The strap is attached to the body. The strap is configured to hold a pipe or duct. The strap includes a locking mechanism. The strap has a diameter that corresponds to a diameter of the pipe or duct when the locking mechanism is engaged. A plurality of MEP hangers may be installed in a prefabricated wall panel or floor panel.

### CROSS REFERENCE TO RELATED APPLICATION

This application claims the benefit of U.S. Provisional Application No. 63/002,492 for MECHANICAL ELECTRICAL AND PLUMBING HANGER SYSTEM filed on Mar. 31, 2020, which is incorporated by reference as if fully set forth.

### FIELD OF INVENTION

The present invention relates generally to installing mechanical, electrical, and plumbing (MEP) in a building, and more specifically to installing MEP by connecting the MEP to floor and/or wall components.

### BACKGROUND

Mechanical, electrical, and plumbing (MEP) must abide by engineering standards. These engineering standards include slope requirements of the pipes or ducts. These requirements have high tolerances which allow little error. MEP is installed in the field. Pipes or ducts are measured and secured to joists in the floor or wall at the engineering standard specified slopes. Installing the MEP in the field according to engineering standards with tight tolerances is tedious, time consuming, and therefore costly.

### SUMMARY

A mechanical, electrical, and plumbing (MEP) hanger is provided. The MEP hanger includes a base, a body, and a strap. The base includes a pin. The pin is configured to engage with an opening in at least one of a web joist, a transverse hanger arm, and a mid-bay hanger arm. The body is attached to the base. The strap is attached to the body. The strap is configured to hold a pipe or duct. The strap includes a locking mechanism. The strap has a diameter that corresponds to a diameter of the pipe or duct when the locking mechanism is engaged. A plurality of MEP hangers may be installed in a prefabricated wall panel or floor panel.

### BRIEF DESCRIPTION

The foregoing summary, as well as the following detailed description will be better understood when read in conjunction with the appended drawings. For the purpose of illustration, there is shown in the drawings different embodiments. It should be understood, however, that the teachings are not limited to the precise mechanical, electrical, and plumbing (MEP) hanger system shown.

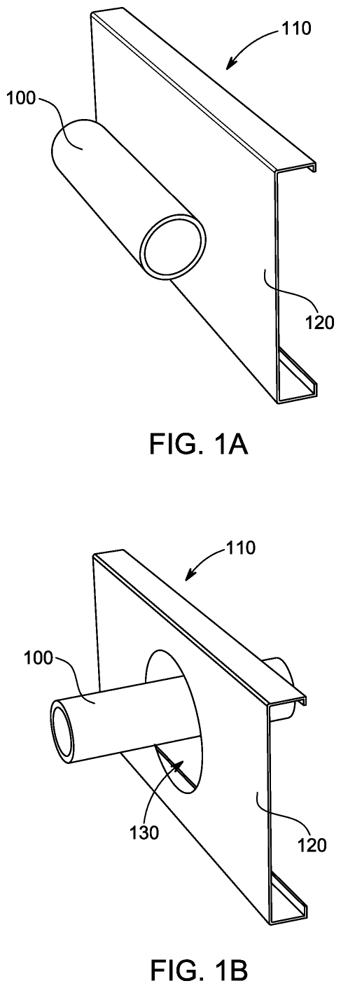

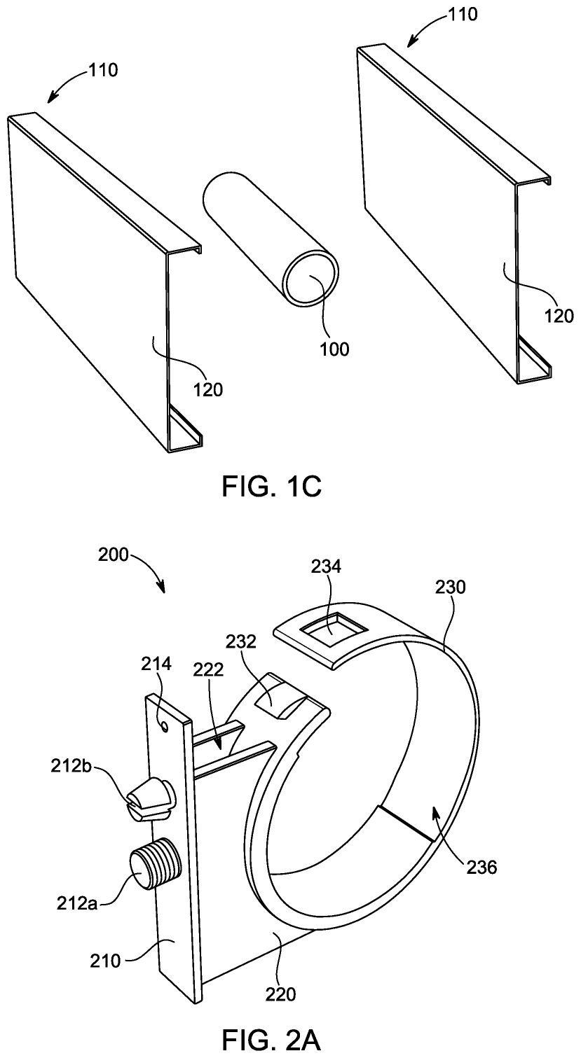

FIG. 1A shows a lateral run condition of a MEP system.

FIG. 1B shows a transverse run condition of a MEP system.

FIG. 1C shows a mid-bay run condition of a MEP system.

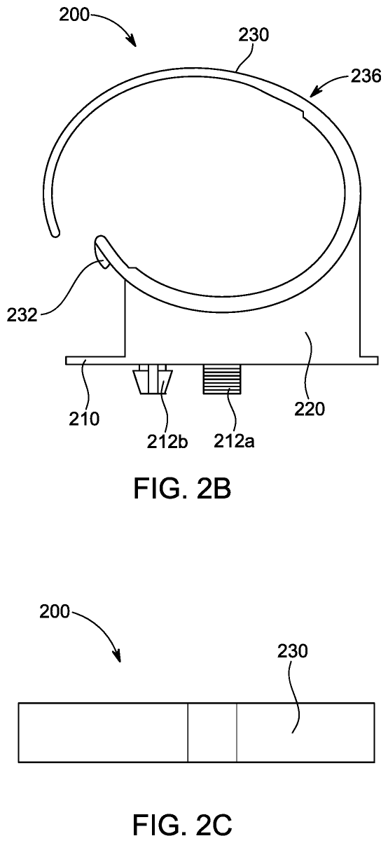

FIG. 2A shows a perspective view of a hanger.

FIG. 2B shows a front view of the hanger.

FIG. 2C shows a top view of the hanger.

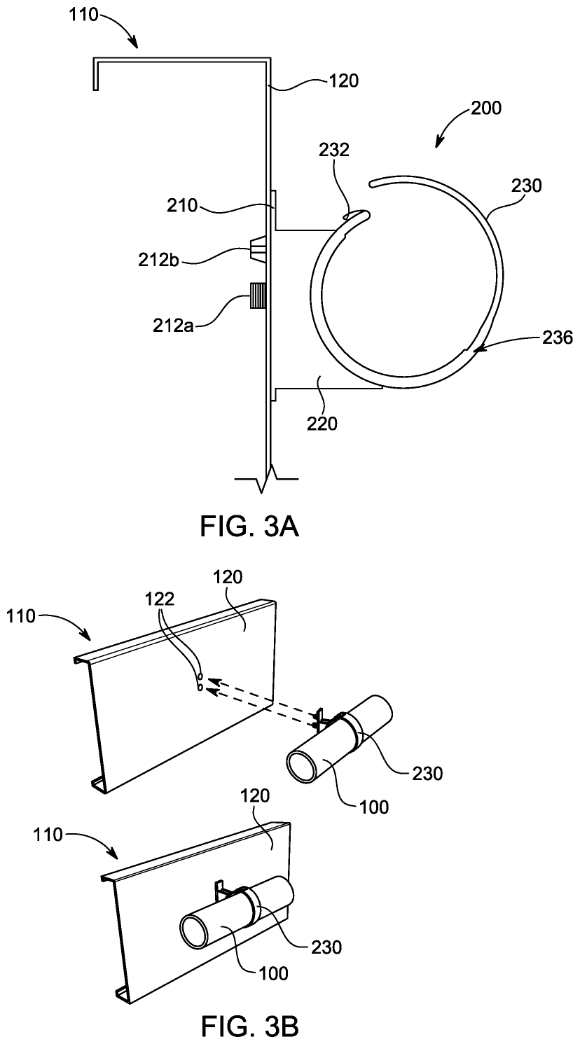

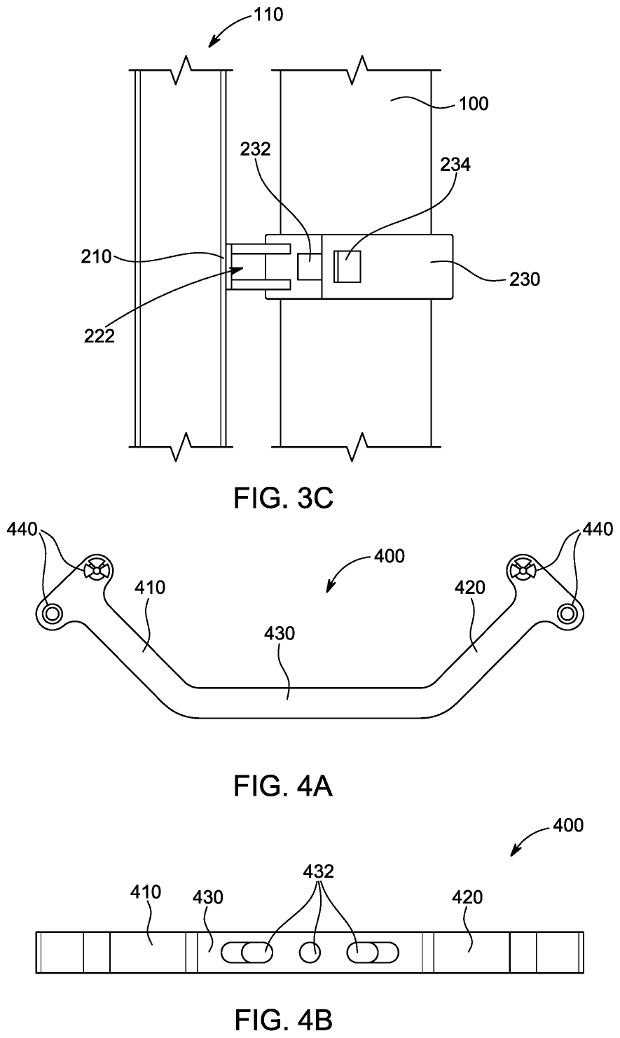

FIG. 3A shows a side view of the hanger attached to the web of a joist.

FIG. 3B shows the hanger being installed to the web.

FIG. 3C shows a top view of the hanger installed to the web with a pipe or duct being secured by the strap of the hanger.

FIG. 4A shows a front view of a transverse hanger arm.

FIG. 4B shows a top view of the transverse hanger arm.

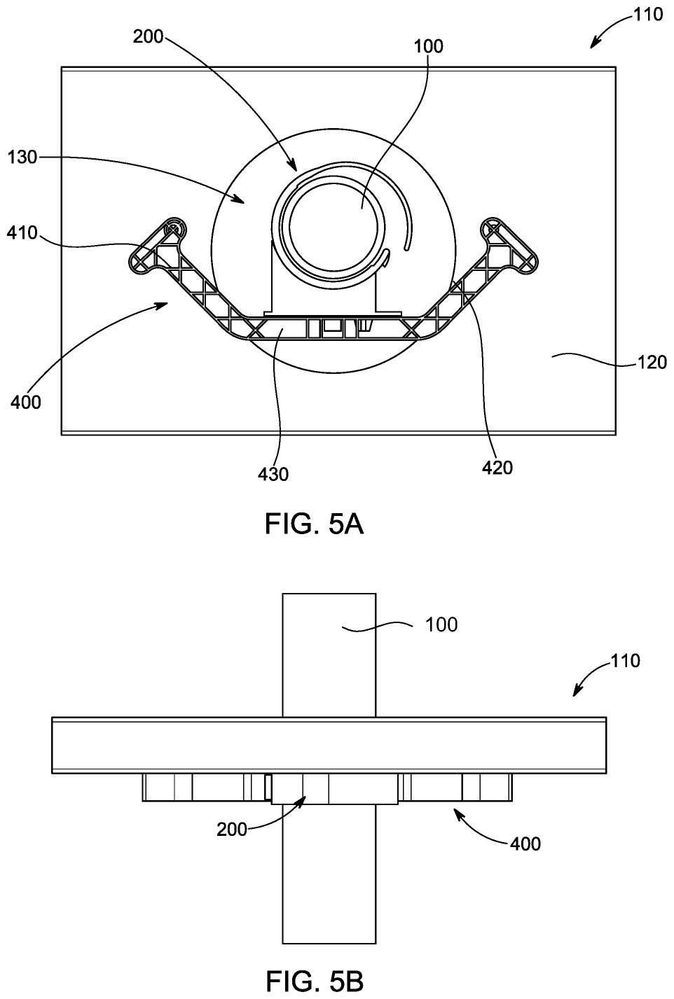

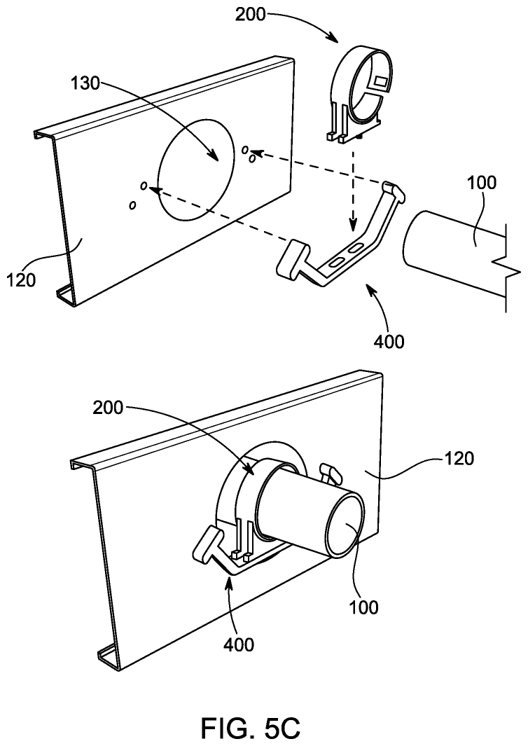

FIG. 5A shows a front view of the transverse hanger arm and hanger used in the transverse run condition.

FIG. 5B shows a top view of the transverse hanger arm and hanger used in the transverse run condition.

FIG. 5C shows the transverse hanger arm being installed to the web.

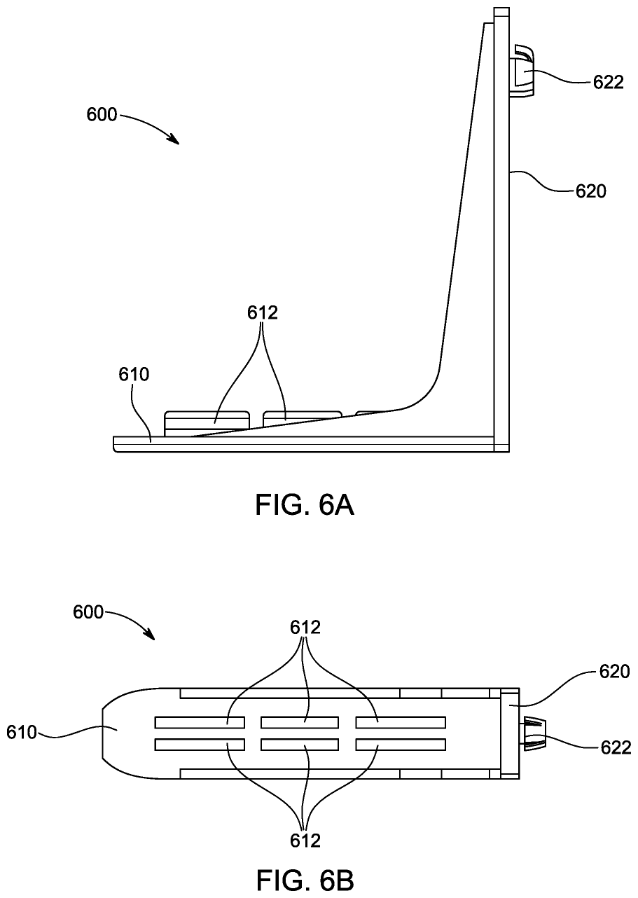

FIG. 6A shows a front view of a mid-bay hanger bracket.

FIG. 6B shows a top view of the mid-bay hanger bracket.

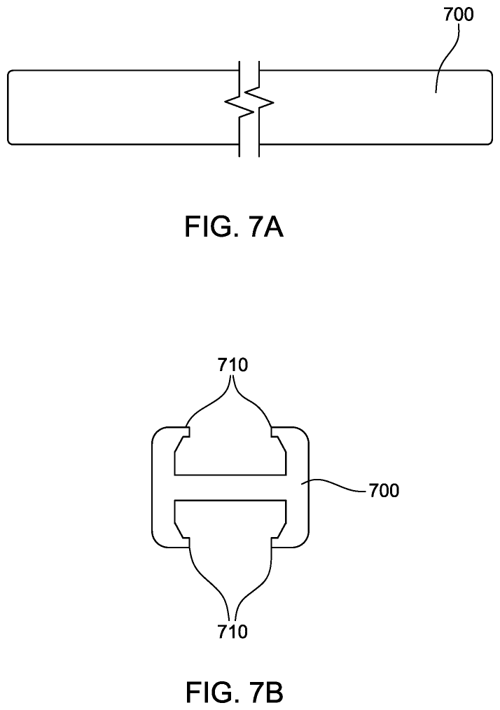

FIG. 7A shows a top view of a mid-bay hanger arm.

FIG. 7B shows an end view of the mid-bay hanger arm.

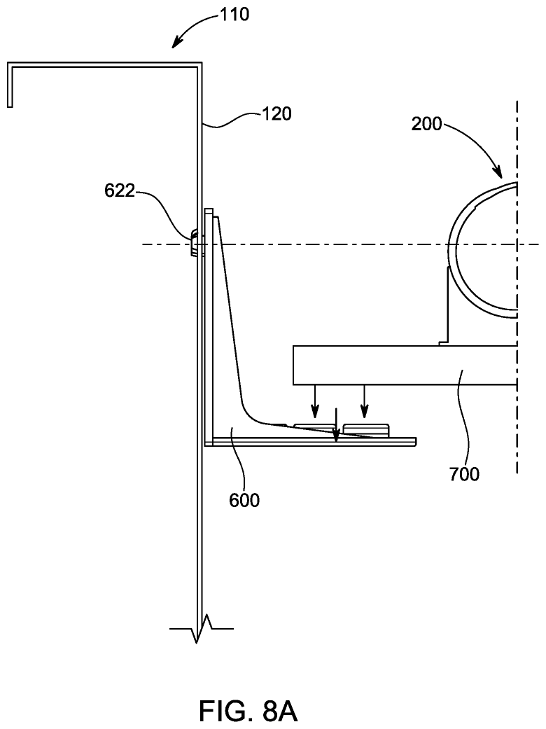

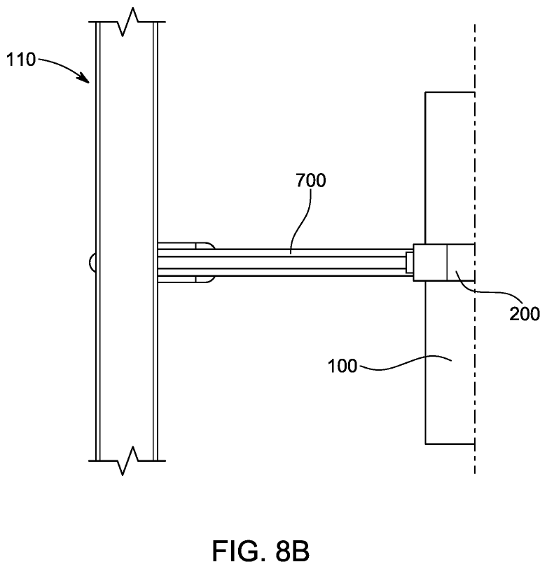

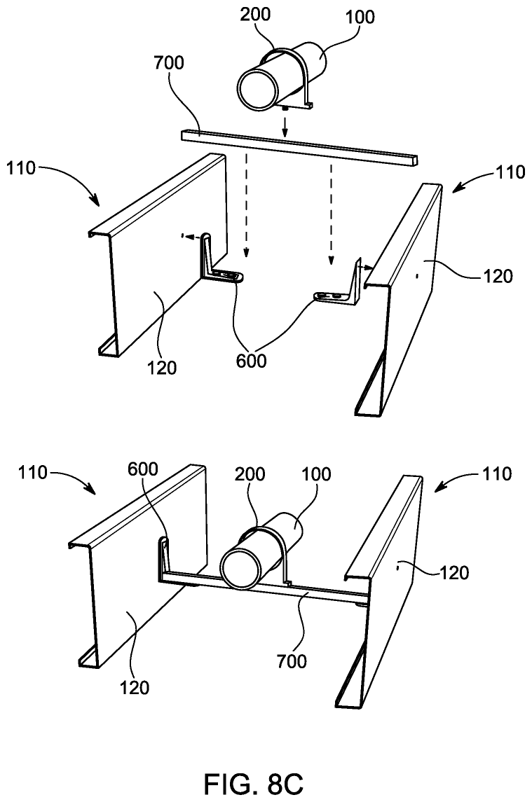

FIG. 8A shows a front view of the mid-bay hanger bracket attached to a web, a mid-bay hanger arm being attached to the bracket and a hanger attached to the mid-bay hanger arm.

FIG. 8B shows a top view of the mid-bay hanger bracket attached to a web, a mid-bay hanger arm attached to the bracket and a hanger attached to the mid-bay hanger arm.

FIG. 8C shows mid-bay hanger brackets being attached to two web joists, a mid-bay hanger arm being attached to the two brackets, and the hanger being attached to the mid-bay hanger arm to secure the pipe or duct to web joists in a mid-bay run condition.

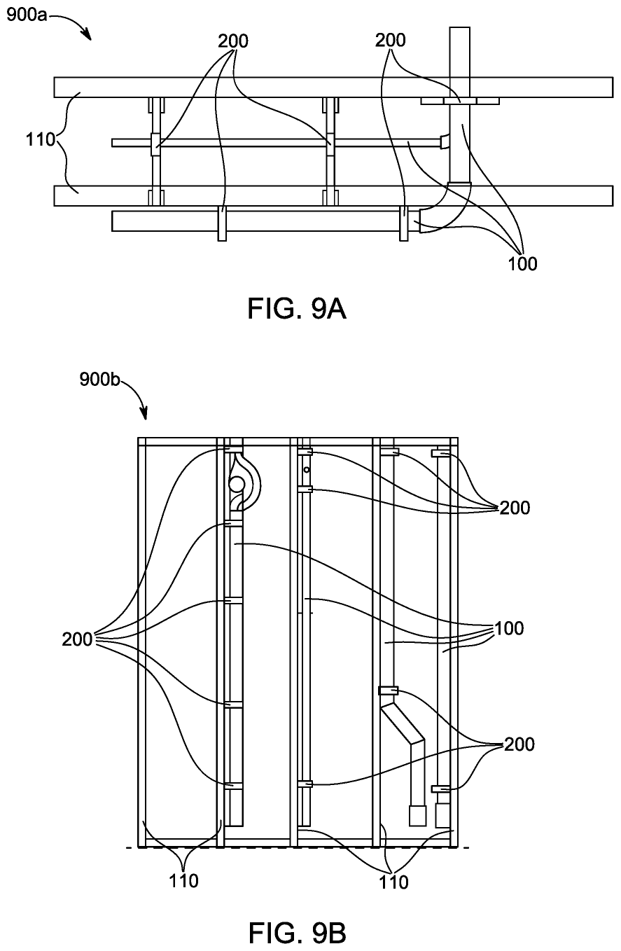

FIG. 9A shows a MEP hanger system for a prefabricated floor panel.

FIG. 9B shows a MEP hanger system for a prefabricated wall panel.

### DETAILED DESCRIPTION

A mechanical, electrical, and plumbing (MEP) hanger system is provided. The MEP hanger system is a system of mounting brackets and hangers to support factory assembly of the MEP. Specifically, the system supports factory assembly and install of MEP in prefabricated floor panels and wall panels. An MEP hanger is provided that connects MEP, specifically pipes and ducts, to floor or wall joists. The MEP hanger and the MEP hanger system are installed in the factory which ensures consistency and efficiency. Factory installation enables consistent placement of the precise location of pipes or ducts. The factory installation also enables rapid installation of an entire MEP factory scope without the need of tools or measuring.

FIGS. 1A-1C show three ways pipes or ducts 100 are supported by wall or floor joists 110. The MEP connector described herein supports the pipes and ducts 100 in each of the conditions shown in FIGS. 1A-1C.

FIG. 1A shows a lateral run condition. The pipes or ducts 100 run parallel to the floor or wall joists 110. The pipes or ducts 100 run closely to the closed joist web 120.

FIG. 1B shows a transverse run condition. The pipes or ducts 100 run perpendicular to the joist 110. The pipes or ducts 100 run through an opening 130 cut in the joist web 120.

FIG. 1C shows a mid-bay run condition. The pipes or ducts 100 run parallel to joists 110 along the centerline between two adjacent joists 110.

FIGS. 2A-2C show a hanger 200. FIG. 2A shows a perspective view of the hanger 200. FIG. 2B shows a front view of the hanger 200. FIG. 2C shows a top view of the hanger 200. The hanger 200 can be used either alone in the lateral run condition or with other components in the transverse run and mid-bay run conditions. The hanger 200 is configured to connect the pipe or duct 100 to a joist 110 or to other components described herein that will indirectly connect the pipe or duct 100 to the joist 110. The hanger 200 may be formed by injection molding. The hanger 200 may be made from nylon 6/6. The hanger 200 includes a base 210, a body 220, and a strap 230. The body 220 is connected to the base 210 and the strap 230.

The base 210 abuts the joist 110 or the other components described herein to indirectly connect the pipe or duct 100 to one or more joists 110. The base 210 includes at least one pin 212a, 212b configured to insert into an opening in a joist 110 or other component. The pins 212a, 212b attach to the joist 110 or other component. The at least one pin 212a, 212b may include a main retention pin 212a. The main retention pin 212a may be of a fir tree configuration to allow use on multiple gauges of sheet metal. The at least one pin 212a, 212b may include a poka-yoke pin 212b. The poka-yoke pin 212b provides backup retention. The top pin 212b may be slightly undersized as compared to the hole or opening which receives the pin 212b to allow the hanger 200 to rotate slightly within construction and engineering tolerances. Alternatively, the pin 212b may be oval to allow the hanger 200 to rotate slightly to achieve the proper slope of the pipe or duct 100 secured by the hanger 200. The base 210 may also include a screw hole 214 configured to receive a screw or other fastener. The screw or fastener extends through the hole 214 and engages with the joist 110 or other component abutting the base 210 to provide additional or back-up support.

The body 220 connects the strap 230 to the base 210. The body 220 may include a through channel 222. The through channel 222 allows a zip-tie or similar device to go through the body 220 and wrap around the closed strap 230 to provide additional or back-up securement.

The strap 230 is attached to the body 220. The strap 230 includes a locking protrusion 232 and a locking recess 234. The locking recess 234 engages with the locking protrusion 232 to lock the strap 230 closed. When the strap 230 is closed, the diameter of the strap 230 should substantially match the diameter of the pipe or duct 100 that it is configured to hold. The diameter substantially matches if it holds the pipe or duct 100 tightly in position when the strap 230 is closed. The strap 230 may include a change in material thickness 236 to allow tension of the locked recess 234 and protrusion 232. The strap 230 may also over hang the pipe which would eliminate the need for grommets on transverse run conditions.

FIGS. 3A-3C show the hanger 200 used in the lateral run condition. FIG. 3A shows a side view of the hanger 200 attached to the web 120 of a joist 110. FIG. 3B shows the hanger 200 being installed to the web 120. FIG. 3C shows a top view of the hanger installed to the web 120 with a pipe or duct 100 being secured by the strap 230 of the hanger 200. As shown in FIG. 3B, there are two openings 122 in the joist web 120. The location of the openings 122 correspond to the location of the pins 212a, 212b of the hanger 200. The pins 212a, 212b insert into the openings 122 and engage with the joist web 120. The pins 212a, 212b secure the hanger 200 to the joist web 120. The openings 122 are predrilled or punched in the joist web 120 at a precise location to hold the pipe or duct 100 at a predetermined slope. The size of the hanger 200 corresponds to the size and weight of the pipe or duct 100.

FIGS. 4A-4B show a transverse hanger arm 400. FIG. 4A shows a front view of the transverse hanger arm 400. FIG. 4B shows a top view of the transverse hanger arm 400. The transverse hanger arm 400 may be formed by injection molding. The transverse hanger arm 400 may be made of nylon 6/6. The transverse hanger arm 400 is used in connection with a hanger 200 to secure a pipe or duct 100 to the web 120 of a joist 110 in a transverse run condition. The transverse hanger arm 400 includes a first arm 410 and a second arm 420 extending from a lateral portion 430. The end of the first arm 410 and the end of the second arm 420 may each include at least one fastening device 440. The fastening devices 440 are configured to secure the transverse hanger arm 400 to the web 120 of a joist 110. The lateral portion 430 of the transverse hanger arm 400 may include at least one opening 432. The openings 432 are configured to receive the pins 212a, 212b of the hanger 200 to secure the hanger 200 to the transverse hanger arm 400. The transverse hanger arm 400 may include multiple openings 432 along the arm 400 to allow the hanger 200 to connect to the transverse hanger arm 400 at different locations.

FIGS. 5A-5C show the transverse hanger arm 400 used in conjunction with the hanger 200 to secure the pipe or duct 100 to the joist web 120. FIG. 5A shows a front view of the transverse hanger arm 400 and hanger 200 used in the transverse run condition. FIG. 5B shows a top view of the transverse hanger arm 400 and hanger 200 used in the transverse run condition. FIG. 5C shows the transverse hanger arm 400 being installed to the web 120. The transverse hanger arm 400 connects to the joist web 120. The first arm 410 and the second arm 420 are at an angle that allows the lateral portion 430 to extend across the opening 130 of the web 120 as shown in FIG. 5A. The hanger 200 connects to the lateral portion 430 of the transverse hanger arm 400. The transverse hanger arm 400 and hanger 200 are positioned to allow the pipe or duct 100 to extend through the opening 130 in the web 120 without interference. As shown in FIG. 5B, the transverse hanger arm 400 abuts the web 120. The pipe or duct 100 runs through the opening 130. As shown in FIG. 5C, the web 120 includes openings to receive the fastening devices 440 of the transverse hanger arm 400. There is an opening for each fastening device 440. The openings are spaced and aligned to position the transverse hanger arm 400 at a location and at a slope that allows the pipe or duct 100 to run through the opening 130 in the web 120 without interference.

FIGS. 6A-6B show a mid-bay hanger bracket 600. FIG. 6A shows a front view of the mid-bay hanger bracket 600. FIG. 6B shows a top view of the mid-bay hanger bracket 600. The mid-bay hanger bracket 600 is used in conjunction with the mid-bay hanger arm 700 shown in FIGS. 7A-7B and a hanger 200 to secure the pipe or duct 100 to two adjacent joist webs 120. The bracket 600 includes a first leg 610 and a second leg 620. The second leg 620 abuts a joist web 120. The first leg 610 extends out approximately perpendicularly from the web 120. The second leg 620 includes at least one pin 622 to secure the bracket 600 to the web 120. The first leg 610 includes a plurality of projecting fastening grooves 612. Each groove 612 may be approximately “T” shaped. The mid-bay hanger bracket 600 may be formed by injection molding. The mid-bay hanger bracket 600 may be made of nylon 6/6.

FIGS. 7A-7B show a mid-bay hanger arm 700. FIG. 7A shows a top view of the mid-bay hanger arm 700. FIG. 7B shows an end view of the mid-bay hanger arm 700. The mid-bay hanger arm 700 may be formed by die extrusion. The mid-bay hanger arm 700 may be made from nylon 6/6. The mid-bay hanger arm 700 extends between two mid-bay hanger brackets 600. The mid-bay hanger arm 700 may be approximately “H” shaped. Both legs of the “H” may be angled inwardly on the ends 710. The size of the “H” corresponds to the size of the first leg 610 of the bracket 600 and grooves 612. The angled ends 710 are configured to slide under the top of the “T” shaped grooves 612 to secure the mid-bay hanger arm 700 to the brackets 600. The “H” and “T” shaped corresponding designs allow the mid-bay hanger arm 700 to slide along the length of the first leg 610.

FIGS. 8A-8C show the mid-bay hanger bracket 600 and mid-bay hanger arm 700 used in conjunction with the hanger 200 to secure the pipe or duct 100 to the joist webs 120. FIG. 8A shows a front view of the mid-bay hanger bracket 600 attached to a web 120, a mid-bay hanger arm 700 being attached to the bracket 600 and a hanger 200 attached to the mid-bay hanger arm 700. FIG. 8B shows a front view of the mid-bay hanger bracket 600 attached to a web 120, a mid-bay hanger arm 700 being attached to the bracket 600 and a hanger 200 attached to the mid-bay hanger arm 700. FIG. 8C shows the mid-bay hanger brackets 600 being attached to two joist webs 120, a mid-bay hanger arm 700 being attached to the two brackets 600, and the hanger 200 being attached to the mid-bay hanger arm 700 to secure the pipe or duct 100 to joist webs 120 in a mid-bay run condition. The at least one pin 622 is inserted into at least one hole in the web 120 thereby securing the bracket 600 to the joist web 120. The holes in the web 120 may be predrilled so that the holes are spaced and located to position the brackets 600, and therefore, the mid-bay hanger arm 700, hanger 200, and pipe or duct 100 at a predetermined slope. Each end of the mid-bay arm 700 attaches to the grooves 612 of the brackets 600. Specifically, the bottom angled ends 710 of the arm 700 slide or snap under the grooves 612. The pins 212a, 212b of the hanger 200 engage with the top angled ends 710 of the mid-bay hanger arm 700.

FIG. 9A shows an example MEP hanger system 900a for a prefabricated floor panel. The MEP hanger system 900a includes a plurality of hangers 200 used in parallel run conditions, transverse run conditions, and mid-bay run conditions. For example, in FIG. 9A, there are two mid-bay run condition hangers 200, two parallel run hangers 200, and a transverse run hanger 200. The number and spacing of the hangers 200 are determined based on engineering standards. The MEP hanger system 900a may be installed in the floor panel in the factory.

FIG. 9B shows an example MEP hanger system 900b for a wall panel. The MEP hanger system 900b includes a plurality of hangers 200 used in parallel run conditions. Although only parallel run hanger conditions are shown in FIG. 9B, transverse run hanger conditions and mid-bay run hanger conditions may also be used in the wall panel when necessary. The MEP hanger system 900b may be installed in the wall panel in the factory.

Having thus described in detail a preferred selection of embodiments of the present invention, it is to be appreciated and will be apparent to those skilled in the art that many physical changes could be made to the MEP hanger system without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A mechanical, electrical, and plumbing (MEP) hanger comprising:
a base including a pin, the pin configured to engage with an opening in at least one of a web joist, a transverse hanger arm, and a mid-bay hanger arm;
a body attached to the base; and
a strap attached to the body, the strap configured to hold a pipe or duct, the strap including a locking mechanism, the strap having a strap diameter corresponding to a diameter of the pipe or duct when the locking mechanism is engaged.

2. The MEP hanger of claim 1 wherein the MEP hanger is formed by injection molding.

3. The MEP hanger of claim 1 wherein the MEP hanger is made of nylon 6/6.

4. The MEP hanger of claim 1 wherein the strap includes a change in material thickness.

5. The MEP hanger of claim 1 further including a second pin.

6. The MEP hanger of claim 1 wherein the locking mechanism includes a locking recess in a first end of the strap and a locking protrusion on a second end of the strap.

7. The MEP hanger of claim 1 wherein the body includes a through channel.

8. The MEP hanger of claim 1 wherein the transverse hanger arm includes a first arm, a lateral portion, and a second arm.

9. The MEP hanger of claim 1 wherein the transverse hanger arm includes at least one fastening device configured to secure the transverse hanger arm to the web joist.

10. The MEP hanger of claim 1 wherein the mid-bay hanger arm is configured to couple with at least one mid-bay bracket.

11. The MEP hanger of claim 10 wherein the at least one mid-bay bracket is configured to couple with the web joist.

12. The MEP hanger of claim 1 wherein the base further includes a second pin configured to engage with a second opening in at least one of the web joist, the transverse hanger arm, and the mid-bay hanger arm.

13. The MEP hanger of claim 1 wherein the MEP hanger is configured to be installed in a prefabricated floor panel.

14. The MEP hanger of claim 1 wherein the MEP hanger is configured to be installed in a prefabricated wall panel.

15. A prefabricated floor panel comprising:
at least one floor joist;
at least one pipe or duct; and
at least one hanger connecting the at least one pipe or duct to the at least one floor joist, the at least one hanger comprising:
a base including a pin, the pin configured to engage with an opening in at least one of the at least one floor joist, a transverse hanger arm, and a mid-bay hanger arm;
a body attached to the base; and
a strap attached to the body, the strap configured to hold the pipe or duct, the strap including a locking mechanism, the strap having a strap diameter corresponding to a diameter of the pipe or duct when the locking mechanism is engaged.

16. The prefabricated floor panel of claim 15 wherein the transverse hanger arm includes at least one fastening device configured to secure the transverse hanger arm to the at least one floor joist.

17. The prefabricated floor panel of claim 15 wherein the mid-bay hanger arm is configured to couple with at least one mid-bay bracket, the at least one mid-bay bracket is configured to couple with the at least one floor joist.

18. A prefabricated wall panel comprising:
at least one wall joist;
at least one pipe or duct; and
at least one hanger connecting the at least one pipe or duct to the at least one wall joist, the at least one hanger comprising:
a base including a pin, the pin configured to engage with an opening in at least one of the at least one wall joist, a transverse hanger arm, and a mid-bay hanger arm,
a body attached to the base, and
a strap attached to the body, the strap configured to hold the pipe or duct, the strap including a locking mechanism, the strap having a strap diameter corresponding to a diameter of the pipe or duct when the locking mechanism is engaged.

19. The prefabricated wall panel of claim 18 wherein the transverse hanger arm includes at least one fastening device configured to secure the transverse hanger arm to the at least one wall joist.

20. The prefabricated wall panel of claim 18 wherein the mid-bay hanger arm is configured to couple with at least one mid-bay bracket, the at least one mid-bay bracket is configured to couple with the at least one wall joist.
